(19) United States
(12) Patent Application Publication
(10) Pub. No.: US 2007/0124316 A1
(43) Pub. Date: May 31, 2007

(54) Attribute selection for collaborative groupware documents using a multi-dimensional matrix

(76) Inventors: John Y. M. Chan, Scarborough (CA); Paul Allan Eeles, Oakville (CA); Sanjeev Sharma, Scarborough (CA); Hendrik Georg Stroebel, Markham (CA)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/288,921

(22) Filed: Nov. 29, 2005

(51) Int. Cl. G06F 7/00

(52) U.S. Cl. 707/100

(57) ABSTRACT

Embodiments of the invention provide a method, system and apparatus for attribute selection for collaborative groupware documents using a multi-dimensional matrix. In an embodiment, an attribute value selection system can include a document database disposed in a groupware system and at least one document stored in the document database. The document can include a multi-dimensional matrix defining valid value combinations for different attributes of the document. Finally, an attribute selection processor can be disposed in the groupware system. The processor can have a configuration to analyze a set of value combinations for different attributes of the at least one document to identify the valid value combinations, and to generate the multi-dimensional matrix. Optionally, the multi-dimensional matrix can be stored in a hidden field for the document.

### BACKGROUND OF THE INVENTION

1. Field of the Invention

The present invention relates to the field of collaborative groupware document management and more particularly to the selection of attributes for collaborative groupware documents.

2. Description of the Related Art

Messaging and groupware, collectively “groupware”, provides electronic mail (e-mail), document storage and document sharing, workflow, group discussions, calendaring and scheduling, and form generation tools. Pioneered by the venerable Notes® software product presently manufactured by IBM Corporation of Armonk, N. Y., groupware systems can incorporate a document database at its core. Consequently, in a conventional groupware system, everything, including e-mail and group discussions, can be maintained in a database, which database can hold data fields, text, audio and video.

Many groupware systems are flexible in that the groupware systems provide only a base degree of functionality. Instead, these groupware systems provide a high degree of customizability which can range from simple scripting language support to complex form and document generation tools. As part of the customization of a groupware document, each groupware document can have a number of attributes or fields. Once the values of each attribute have been assigned, the resulting document can be considered to be valid for each possible combination of the selected values for each field.

Thus, if a groupware document has two attributes whose assigned values form two sets as A & B respectively, then it is considered to be valid for all possible combinations of those assigned values as given by their cross product or Cartesian product:
A×B={(a,b)|a∈A·and·b∈B}
Yet, in some circumstances, one or more of the resulting tuples can be unintentional and invalid.

For example, considering the hypothetical groupware document which has the attributes entitled “Planet” and “Element”, the values of Earth and Mars can be assigned to the Planet attribute and the values of Water and Air can be assigned to Element attribute. In this example, assuming Mars does not have water, while the tuples Earth&Water, Earth&Air and Mars&Air are valid, the tuple Mars&Water would be an invalid selection. Notwithstanding, the cross-product of the attribute values for Planet and Element otherwise permit this invalid selection.

### BRIEF SUMMARY OF THE INVENTION

Embodiments of the present invention address the deficiencies of the art in respect to the assignment of attributes to a groupware document and provide a novel and non-obvious method, system and apparatus for attribute value selection for attribute values of a document in a groupware system. In an embodiment of the present invention, a method for attribute value selection for attribute values of a document in a groupware system can include defining an allowable multi-dimensional matrix of valid relationships between attributes. The method further can include analyzing various combinations of different assigned attributes of a document in the groupware system to identify applicable combinations for the document.

The method further can include generating an applicable multi-dimensional matrix defining the valid value combinations for the given document, identified as a result of the said analysis. The generated multi-dimensional matrix will be a subset of the matrix containing all possible, allowable relationships between attributes. The method further can include associating the said document to said applicable multi-dimensional matrix within the said document or in a storage solution. Finally, the method can include processing the applicable multi-dimensional matrix to identify the associated documents.

As an example, the processing step can include saving the document to a document database in the groupware system. As another example, the processing step can include retrieving the document from a document database in the groupware system based upon selected attribute values. As yet another example, the processing step can include synchronizing the document with the document database in the groupware system if the allowable multi-dimensional matrix changes. Optionally, the synchronizing step can include filtering documents from the synchronization which have attribute value combinations determined to be invalid by virtue of not appearing in the allowable multi-dimensional matrix. The synchronizing step yet further can include storing the filtered documents in a folder or view of filtered documents.

In one aspect of the invention, the method can include appending the applicable multi-dimensional matrix to a hidden field associated with the document. In this aspect, the applicable multi-dimensional matrix can be stored as a one dimensional list if the groupware facility does not have the ability to define and work with multiple attributes at the same time. In this aspect, the processing step can include parsing the hidden field to identify a 1-tuple for each n-tuple representing a valid combination of attribute values for the document and reproducing attribute fields in the groupware system for the document using the 1-tuples. In this aspect, the method also can include storing the applicable multi-dimensional matrix to the hidden field associated with the document in lieu of storing values for each of the attributes independently of the multi-dimensional matrix.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a groupware data processing system configured for attribute selection using an allowable multi-dimensional matrix;

FIG. 2A is a flow chart illustrating a process for filtering documents based upon invalid attributes determined according to the allowable multi-dimensional matrix in the groupware system of FIG. 1; and,

FIG. 2B is a flow chart illustrating a process for generating an applicable matrix according to the allowable multi-dimensional matrix in the groupware system of FIG. 1.

### DETAILED DESCRIPTION OF THE INVENTION

Embodiments of the present invention provide a method, system and apparatus for attribute selection in a groupware document using multi-dimensional matrices. In an embodiment of the present invention, an allowable multi-dimensional matrix (M_{Allowable}) can be defined for only valid combinations of attribute values. For a given document, a multi-dimensional matrix (M_{Possible}) can be generated based on all possible combinations of assigned attribute values of said document. M_{Possible} may include both valid attribute combinations as defined in the matrix M_{Allowable} and invalid attribute combinations not defined in M_{Allowable}. Subsequently, an applicable multi-dimensional matrix (M_{Applicable}) of all valid attribute combinations for a given document can be generated based on the set intersection of M_{Allowable} and M_{possible}, as depicted in FIG. 3 below.
M_{Applicable}=M_{Allowable}∩M_{Possible}

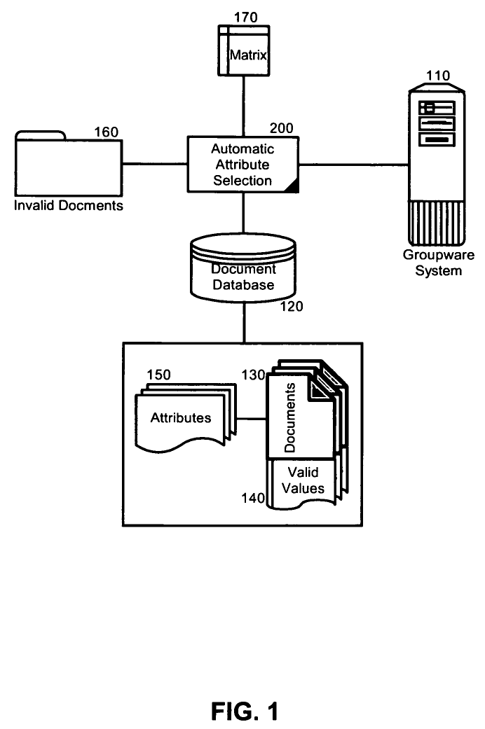

This applicable multi-dimensional matrix is associated with or stored with the document in the document database of the groupware system. As an example, an applicable multi-dimensional matrix (M_{Applicable}) can be stored as a hidden field to the document. In more particular illustration, FIG. 1 is a schematic illustration of a groupware system 110 configured for attribute selection using a multi-dimensional matrix. The groupware data processing system 110 can include a document database 120 storing one or more documents 130. The groupware system 110 further includes an allowable multi-dimensional matrix 170 of valid attribute relationships which can be defined by the end user to include the allowable universe of valid attribute relationships.

Each of the documents 130 can have attributes 150. Each of the attributes 150, in turn, can have one or more assigned values selected from the allowable multi-dimensional matrix 170. Importantly, an attribute selection process 200 can be coupled to the groupware system 110. For a given document 130, the attribute selection process 200 can generate an applicable multi-dimensional matrix 140 from validation of attribute relationships from combinations of attributes 150 (which represent the selected values of the attributes for the document 130) and the allowable multi-dimensional matrix 170 by filtering out invalid combinations of valid sub-choices. Each document 130 is associated with its own applicable multi-dimensional matrix 140. Thus applicable multi-dimensional matrix 140 represents a set of valid tuples associated with document 130 in the document database 120. The attribute selection process 200 can identify documents where the associated applicable matrix 140 is empty and can categorize the document as an invalid document 160.

As one aspect, when assigning values to attributes 150 in documents 130, the attribute selection process 200 can present valid sub-choices using allowable multi-dimensional matrix 170. Further this aspect avoids the creation of invalid documents except when allowable multi-dimensional matrix 170 changes and a synchronization process is required to identify the invalid documents. The synchronization can include filtering documents which have attribute value combinations determined to be invalid by virtue of not appearing in the allowable multi-dimensional matrix 170. The synchronization yet further can include storing the filtered documents in a folder or view of filtered documents. As another aspect, allowable multi-dimensional matrix 170 can be generated from existing documents assuming all attribute value combinations in said documents are valid.

Each combination of valid attribute values in the applicable multi-dimensional matrix 140 can be represented in a table in the groupware system 110 where each row represents a valid attribute combination from the matrix and each column represents an attribute value 150 for the valid combination. An additional column is used to associate the table row with document 130. Alternatively, each combination of valid attribute values in the applicable multi-dimensional matrix 140 can be concatenated into a 1-tuple and included in a list in a hidden field of document 130. In this example the association is implicit as the applicable multi-dimensional matrix 140 is stored within the document 130. Finally, as yet another alternative, the applicable multi-dimensional matrix 140 can be stored in the document 130 as a key. In this way, if the document 130 and the applicable multi-dimensional matrix 140 become separated, the key in the document 130 can be used to reconstruct the applicable multi-dimensional matrix 140.

When one of the documents 130 is to be retrieved from the document database 120, the initially selected attributes for the document 130 can be presented along with the assigned values for those attributes, and the applicable multi-dimensional matrix 140 can be disregarded. The attribute selection process 200 can regenerate the applicable multi-dimensional matrix 140 when the document is changed. Specifically, if a document 130 is re-opened and altered, that attribute selection process 200 would run again to rebuild the applicable matrix 140 since the values used in the applicable matrix 140 may have changed. Without regenerating the applicable multi-dimensional matrix 140, the applicable matrix may include combinations which are no longer be valid. Alternatively, disk space can be conserved by saving only the associated applicable multi-dimensional matrix and not the original attributes. At the time of document retrieval, the applicable multi-dimensional matrix 140 can be used to repopulate the original attribute values resulting in a savings of disk space.

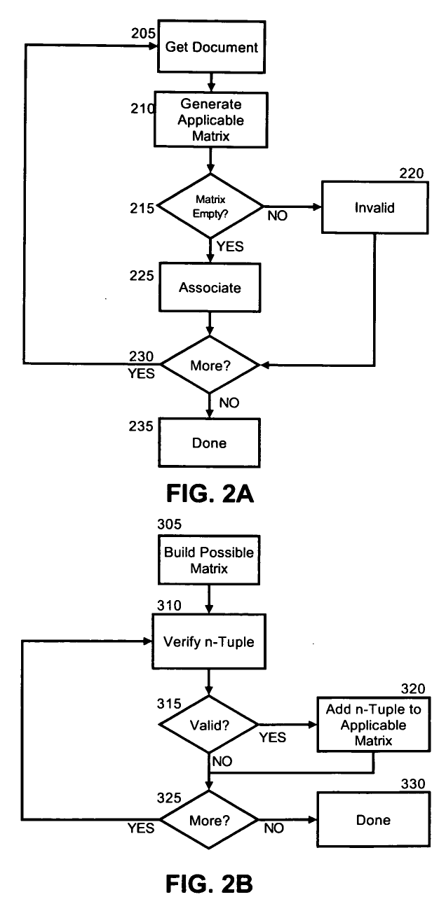

In more particular illustration, FIG. 2A is a schematic illustration of synchronizing existing documents in a groupware system, with respect to an allowable multi-dimensional matrix, to generate an applicable multi-dimensional matrix and to identify documents with an empty applicable multi-dimensional matrix. At the outset in block 205 a first document can be retrieved for synchronization. The assigned attributes for the document are then used in block 210 to build an applicable multi-dimensional matrix of valid combinations of attribute values.

If, in decision block 215, it is determined that the applicable multi-dimensional matrix is empty, occurring when no valid attribute combinations exist, then the document can be identified as an invalid document in block 220. Otherwise, if the matrix is not empty, then it can be associated with the document in block 225. If additional documents remain to be synchronized in decision block 230, then the next document can be retrieved for synchronization in block 205. When no more documents remain to be synchronized in decision block 230, the process can end in block 235.

Returning to FIG. 1, when saving documents 130 to the document database 120, the attribute selection process 200 can generate an applicable multi-dimensional matrix of valid combinations of attribute values 150. More specifically, referring to FIG. 2B, in block 305 a multi-dimensional matrix of all possible attribute combinations is generated based on the Cartesian product of the attribute values. Each row of this possible matrix is an n-tuple representing a single combination of the attribute values.

In block 310, the first n-tuple is then validated against the allowable multi-dimensional matrix 170 of FIG. 1. If, in decision block 315, it is determined to be a valid n-tuple, then the n-tuple can be added to the applicable multi-dimensional matrix in block 320. If additional n-tuples remain to be validated in decision block 325, then the next n-tuple is validated in block 310. When no more n-tuples remain to be validated in decision block 325, the applicable matrix generation process can end in block 330.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. An attribute value selection method for selecting attribute values of a document in a groupware system comprising:
defining an allowable multi-dimensional matrix of valid attribute combinations from a plurality of documents;
generating an applicable multi-dimensional matrix from said valid attribute combinations;
associating said applicable multi-dimensional matrix with the document; and,
processing the document in accordance with said applicable multi-dimensional matrix.

2. The method of claim 1, wherein said defining step comprises:
generating said allowable multi-dimensional matrix from existing plurality of documents assuming all attribute value combinations in said existing plurality of documents are valid.

3. The method of claim 1, wherein said generating step comprises:
analyzing a set of value combinations for different attributes of the document to identify valid ones of said valid attribute combinations.

4. The method of claim 1, wherein said associating step comprises:
saving said applicable multi-dimensional matrix within the document to a document database.

5. The method of claim 1, wherein said associating step comprises:
saving said applicable multi-dimensional matrix outside of the document.

6. The method of claim 5, further comprising:
storing a key to the document with said applicable multi-dimensional matrix.

7. The method of claim 5, further comprising:
appending said applicable multi-dimensional matrix to a file path associated with the document.

8. The method of claim 1, wherein said processing step comprises:
synchronizing the document with said allowable multi-dimensional matrix.

9. The method of claim 8, wherein said synchronizing step comprises the step of filtering documents which have attribute value combinations determined to be invalid for having not appeared in said allowable multi-dimensional matrix.

10. An attribute value selection data processing system comprising:
a document database disposed in a groupware system;
at least one document stored in said document database comprising at least two multi-value attributes;
an allowable multi-dimensional matrix defining valid value combinations for different attributes; and,
an attribute selection processor disposed in said groupware system, said processor having a configuration to analyze a set of value combinations for different attributes of said at least one document to identify said valid value combinations: and,
a generator to generate an applicable multi-dimensional matrix from the identified valid value combinations.

11. The data processing system of claim 10, wherein said applicable multi-dimensional matrix is stored in said document.

12. A computer program product comprising a computer usable medium including computer usable program code for attribute value selection for attribute values of a document in a groupware system, said computer program product including:
computer usable program code for defining an allowable multi-dimensional matrix of valid attribute combinations from a plurality of documents;
computer usable program code for generating an applicable multi-dimensional matrix defining said valid attribute combinations;
computer usable program code for associating said applicable multi-dimensional matrix with the document; and,
computer usable program code for processing the document responsive to said applicable multi-dimensional matrix.

13. The computer program product of claim 12, wherein said defining comprises generating said allowable multi-dimensional matrix from existing documents assuming all attribute value combinations in said existing documents are valid.

14. The computer program product of claim 12, wherein said generating comprises analyzing a set of value combinations for different attributes of the document to identify valid ones of said valid attribute combinations.

15. The computer program product of claim 12, wherein said associating comprises saving said applicable multi-dimensional matrix within the document to a document database.

16. The computer program product of claim 12, wherein said associating comprises saving said applicable multi-dimensional matrix outside of the document.

17. The computer program product of claim 16, further comprising computer usable code for storing a key to the document with said applicable multi-dimensional matrix.

18. The computer program product of claim 16, further comprising computer usable code for appending said applicable multi-dimensional matrix to a file path associated with the document.

19. The computer program product of claim 16, wherein said processing comprises synchronizing the document with said allowable multi-dimensional matrix.

20. The computer program product of claim 19, wherein said synchronizing comprises filtering documents which have attribute value combinations determined to be invalid for having not appeared in said allowable multi-dimensional matrix.
